(19) United States
(12) Patent Application Publication
(10) Pub. No.: US 2026/0265496 A1
(43) Pub. Date: Sep. 10, 2026

(54) HIGH-PURITY ALUMINA PARTICLES AND METHOD OF PRODUCING SAME, AND RESIN COMPOSITION FOR ELECTRONIC DEVICES AND METHOD OF PRODUCING THE SAME

(71) Applicant: ADMATECHS CO., LTD., Miyoshi-shi, Aichi (JP)

(72) Inventor: Yusuke WATANABE, Miyoshi-shi (JP)

(73) Assignee: ADMATECHS CO., LTD., Miyoshi-shi, Aichi (JP)

(21) Appl. No.: 19/162,116

(22) PCT Filed: Jun. 11, 2024
(86) PCT No.: PCT/JP2024/021172

§ 371 Date: Sep. 4, 2025

(30) Foreign Application Priority Data
Jun. 14, 2023 (JP) 2023-097978

(51) Int. Cl. C08K 7/18; C01F 7/422; C01F 7/46; C08J 3/21

(52) U.S. Cl. CPC C08K 7/18; C01F 7/422; C01F 7/46; C08J 3/212; C01P 2004/32; C01P 2004/61; C01P 2006/80

(57) ABSTRACT

There are provided high-purity alumina particles in which purity is increased by reducing the amount of impurities remaining in alumina particles derived from metallic aluminum and reducing the amount of metallic aluminum itself and a method of producing the same. The content of elemental uranium in the alumina particles derived from metallic aluminum is 5 ppb or less, the content of elemental thorium is 5 ppb or less, the content of metallic aluminum is 5 ppm or less, the content of sodium is 10 ppm or less, and the content of iron is 10 ppm or less, a metallic aluminum powder is put into a flame, vaporized, and oxidized, and the spherical alumina particles are obtained through spheroidization due to surface tension during cooling, the spherical alumina particles are put into a basic solution to dissolve metallic aluminum remaining in the particles, and the spherical alumina particles are dried.

### TECHNICAL FIELD

The present invention relates to high-purity alumina particles and a method of producing the same, as well as a resin composition for electronic devices containing high-purity alumina particles and a method of producing the same.

### BACKGROUND ART

In the case of encapsulants for sealing precision electronic components such as semiconductors, inorganic material fillers are added to a resin composition. The fillers are required to have insulating properties and a low coefficient of thermal expansion. Generally, alumina (aluminum oxide) and the like are often used.

Alumina is processed into fillers by crushing natural high-purity ores to a predetermined particle size. That is, even if it has high purity, the presence of impurities other than aluminum oxide is unavoidable because it is derived from natural ores. In particular, in the case of alumina derived from natural products, elemental uranium and elemental thorium are present. In order to improve the processing speed of semiconductors, further advancements in processing precision and integration have been performed.

Therefore, the influence of electromagnetic noise on semiconductors received from the outside is considered more problematic than even before. It is known that, in the case of alumina derived from natural products, alpha rays and the like are generated due to radioactive decay of elemental uranium and elemental thorium, which are thought to cause malfunctions.

Therefore, a production method including crushing and exposure to a flame in combination has been proposed to reduce the amount of impurities contained in the resulting fillers and the like (refer to PTL 1). In addition, in order to improve the production method in PTL 1 and the like, a production method in which raw materials in a metallic state such as aluminum are processed into oxides, and the impurity aluminum is then dissolved in a basic solution has been proposed (refer to PTL 2).

According to conventional production methods, significant progress has been made in reducing the amount of impurity components. However, it is not easy to dissolve amphoteric metal elements such as aluminum in a basic solution. In particular, in the case of aluminum, depending on the purity of the metallic state, there is a problem of an oxide film being formed on the metal surface, which may inhibit dissolution in a basic solution.

### CITATION LIST

### Patent Literature

PTL 1: Japanese Unexamined Patent Application Publication No. 2012-206870
PTL 2: Japanese Unexamined Patent Application Publication No. 2014-101239

### SUMMARY OF INVENTION

### Technical Problem

Thereafter, the inventors conducted extensive studies regarding dissolution of metallic aluminum in a basic solution. As a result, the inventors discovered that appropriately controlling dissolution of metallic raw materials in a basic solution increases the efficiency of dissolving metallic aluminum in a basic solution and reduces the amount of impurity components originating from metallic raw materials.

The present invention has been made in view of the above circumstances and provides high-purity alumina particles which are used as a filler added to an encapsulant, in which purity is increased by reducing the amount of impurities remaining in alumina particles derived from metallic aluminum and reducing the amount of metallic aluminum itself and a method of producing the same, and a resin composition for electronic devices using the high-purity alumina particles and a method of producing the same.

### Solution to Problem

That is, the high-purity alumina particles according to the embodiment are alumina particles derived from metallic aluminum, wherein the content of elemental uranium in the alumina particles is 5 ppb or less, the content of elemental thorium in the alumina particles is 5 ppb or less, the content of metallic aluminum in the alumina particles is 5 ppm or less, the content of sodium in the alumina particles is 10 ppm or less, and the content of iron in the alumina particles is 10 ppm or less.

In addition, in the high-purity alumina particles, the amount of remaining aluminum particles having a particle size of 20 μm or more derived from the raw material metallic aluminum may be 10 particles or less per 50 g of the alumina particles.

In addition, a resin composition for electronic devices includes high-purity alumina particles and a resin composition.

A method of producing high-purity alumina particles according to an embodiment includes a particle formation step in which a metallic aluminum powder is put into a flame, vaporized, and oxidized, and spherical alumina particles are obtained through spheroidization due to surface tension during cooling, a dissolving step in which the spherical alumina particles are put into a basic solution to dissolve metallic aluminum remaining in the spherical alumina particles, and a drying step in which the spherical alumina particles are dried.

In addition, in the method of producing high-purity alumina particles, the basic solution may be an aqueous amine compound solution.

In addition, in the method of producing high-purity alumina particles, in the dissolving step, the spherical alumina particles may be dissolved in the basic solution having a pH of 9 or more and a liquid temperature of 20 to 60° C. to dissolve metallic aluminum remaining in the spherical alumina particles.

In addition, in the method of producing high-purity alumina particles, in the dissolving step, the spherical alumina particles may be sieved.

In addition, in the method of producing high-purity alumina particles, a washing step in which the spherical alumina particles are washed may be added.

In addition, a method of producing a resin composition for electronic devices includes a particle formation step in which a metallic aluminum powder is put into a flame, vaporized, and oxidized, and spherical alumina particles are obtained through spheroidization due to surface tension during cooling, a dissolving step in which the spherical alumina particles are put into a basic solution having a pH of 9 or more and a liquid temperature of 20 to 60° C. to dissolve metallic aluminum remaining in the spherical alumina particles, a drying step in which the spherical alumina particles are dried, and a resin dispersion step in which the spherical alumina particles that have been subjected to the drying step are dispersed in a resin composition to obtain a resin dispersion.

### Advantageous Effects of Invention

According to the high-purity alumina particles and the method of producing high-purity alumina particles of the present invention, it is possible to obtain high-purity alumina particles, which are alumina particles for a filler added to an encapsulant, in which purity is increased by reducing the amount of metallic aluminum remaining in alumina particles derived from metallic aluminum and it is also possible to achieve a method of producing the same.

In addition, according to the resin composition for electronic devices and the method of producing the same, it is possible to reduce the dose of particle rays and electromagnetic waves emitted from the spherical particles contained in the resin composition, and it is expected that, by reducing external disturbance factors such as noise, problems such as device malfunction will be reduced.

### DESCRIPTION OF EMBODIMENTS

When high-purity alumina particles according to an embodiment are prepared, a production method in which the raw material, a metallic aluminum powder, is subjected to the following steps in order is performed. In addition, the resin composition for electronic devices is a resin composition containing high-purity alumina particles, and the production method thereof includes a step of dispersing the alumina particles in the resin composition in the final stage. The high-purity alumina particles are alumina particles of which 99.8% or more of the total weight is aluminum oxide.

First, a metallic aluminum powder is prepared as a raw material, and the metallic aluminum powder is put into a flame. In the flame, the metallic aluminum powder is vaporized and oxidized. The aluminum oxide (alumina) produced by oxidation cools from a gas to a liquid. In this case, the aluminum oxide (alumina) becomes spherical due to surface tension. As a result, fine spherical alumina particles are generated (“particle formation step”). This step is a type of a deflagration reaction, and is called a vaporized metal combustion method (VMC method) or the like.

The flame in the particle formation step is formed by mixing a combustion supporting gas containing oxygen with a combustible gas and burning it. As an index of the temperature inside the furnace, the temperature of the fireproof structure of the furnace is in a range of 900° C. to 1,500° C. at the highest position (furnace body temperature). The lower limit value of the furnace body temperature is preferably 900° C. to 1,100° C., and the upper limit value thereof is preferably 1,300° C. to 1,500° C. As the combustion supporting gas, air or oxygen is used. When the combustible gas and the combustion supporting gas are supplied into the furnace, they may be supplied separately or may be supplied in a premixed state.

The flow rate of the combustible gas is preferably 0.1 m/s or more, more preferably 0.5 m/s or more, and still more preferably 1 m/s or more. The flow rate of the combustion supporting gas is preferably 5 m/s or more, more preferably 7 m/s or more, and still more preferably 9 m/s or more. The flow rate ratio of combustible gas/combustion supporting gas is preferably 0.5 or less, more preferably 0.3 or less, and still more preferably 0.1 or less. The amounts of the combustible gas and the combustion supporting gas supplied are determined according to the amount of the combustible gas necessary to form a flame large enough to sufficiently heat a raw particle material to be supplied and the amount of the combustion supporting gas necessary to sufficiently burn the combustible gas. For example, the amount of the combustible gas per unit weight of the crushed component to be treated is set to 0.5 Nm³/h to 5 Nm³/h, and the amount of oxygen as the combustion supporting gas is set to about 50 Nm³/h to 500 Nm³/h.

The method of supplying a metallic aluminum powder to a flame is not particularly limited, but the powder that is dispersed in a carrier gas can be supplied to the flame. Examples of carrier gases include air, oxygen, and nitrogen.

In the spherical alumina particles produced in the particle formation step, not all of the metallic aluminum is necessarily oxidized to aluminum oxide, and a small amount of the metallic aluminum may remain. Therefore, in order to remove metallic aluminum, the spherical alumina particles are put into a basic solution, and the metallic aluminum remaining in the spherical alumina particles is dissolved (“dissolving step”).

The basic solution used to dissolve metallic aluminum, which is an amphoteric element, in a basic solution is a solution containing no alkali metals. Generally, the aqueous solution of alkali metal hydroxides such as lithium hydroxide, sodium hydroxide, and potassium hydroxide is strongly basic. However, if the alkali metals in the basic solution remain in the spherical alumina particles, this is undesirable because they reduce the purity of the finally produced spherical alumina particles.

Here, as the basic solution containing no alkali metals, an aqueous amine compound solution is used. Examples of amine compounds include ammonia, primary amines, secondary amines, tertiary amines, quaternary ammonium hydroxides (ammonium salts), arylamines, silazanes, and hydrazine.

More specifically, the amine compound is at least one compound selected from among ammonia, methylamine, ethylamine, propylamine, dimethylamine, diethylamine, pyrrolidine, trimethylamine, triethylamine, tetramethylammonium hydroxide, tetraethylammonium hydroxide, tetrabutylammonium hydroxide, benzyltrimethylammonium hydroxide, methyltriamylammonium hydroxide, methyltriamylammonium hydroxide, methyltributylammonium hydroxide, pyrrolidine, piperidine, pyridine, quinoline, imidazole, indole, pyrimidine, hexamethyldisilazane, hydrazine, diazabicycloundecene, and diazabicyclononene. When the aqueous solution is prepared, the amine compound may be of a single type or a mixture of two or more types.

When an amine compound, which is an organic compound, is used, the compound molecules volatilize and decompose during treatments in the subsequent steps. Therefore, the amine compound is desirable because it hardly remains in the finally produced spherical alumina particles. Of course, regarding the concentration of the amine compound in the aqueous solution, when the metallic aluminum remaining in the spherical alumina particles is dissolved, the pH of the basic solution is 9 or more, and the pHis more preferably 10 or more, and the metallic aluminum remaining in the spherical alumina particles is heated in the basic solution under a condition of a liquid temperature of 20 to 60° C. and more preferably a liquid temperature of about 40 to 60° C. When the temperature is lower than 40° C., it takes a long time for precipitation to occur. In addition, when the temperature exceeds 60° C., precipitation is less likely to occur due to the influence of the liquid temperature. According to examples to be described below, this is based on the findings that control of mainly pH and temperature conditions is effective in reducing the amount of undissolved metallic aluminum.

Here, regarding the relationship between the amount of the base and the amount of metallic aluminum to be dissolved, the amount of the base (wt %) relative to the amount of metallic aluminum (Al) (g) is preferably in a range of 0.04 to 2 wt %. The amount of the base is converted from a molar amount to wt % (weight percent) for ease of weighing it out.

It is known that the metallic aluminum remaining in the spherical alumina particles forms an oxide film of alumina (such as alumite) on the metal surface when reacting with an acid or a base. When an oxide film is formed on the surface, the hydroxide formation reaction is completed without the base and the like coming into contact with the internal metallic aluminum relative to the oxide film. That is, un-melted (undissolved) metallic aluminum is unavoidably produced. Therefore, it is necessary to promote the hydroxide formation by reacting metallic aluminum with a basic solution (aqueous amine compound solution) as vigorously as possible. It is speculated that, since an oxide film formed on the surface of high-purity aluminum, that is, high-purity alumina, has a high purity, the oxide film cannot be completely dissolved with a base such as ammonia, and as a result, the internal aluminum does not dissolve.

The above conditions are conditions for gradually causing the reaction to proceed at a mild temperature close to room temperature while securing the pH required for forming aluminum hydroxide. Of course, the conditions are adjusted depending on the type and concentration of the amine compound used.

In addition, in the dissolving step, as necessary, the spherical alumina particles are sieved. Although the particles can be spheroidized in the particle formation step, it is not possible to uniformize the particle size of the spherical alumina particles. In addition, in the dissolving step, the spherical alumina particles may disintegrate due to the influence of the strong base during the dissolution. Therefore, prior to the following step, spherical alumina particles having non-uniform particle sizes are removed by sieving. For sieving, a known sieve (filter) or the like is used, and the spherical alumina particles are separated according to a predetermined particle size.

After the dissolving step, the spherical alumina particles are dried (“drying step”). Here, before the drying step, the spherical alumina particles are washed in order to remove the basic solution (“washing step”). First, in the washing step, the spherical alumina particles are washed with water. The washing device and the number of washings are appropriate, and washing with water is completed when the pH of wastewater after washing reaches about 7. In the drying step, natural drying, drying by exposure to warm air or hot air using a dryer or the like is appropriate.

The spherical alumina particles that are produced through the drying step tend to be large or non-uniform due to aggregation during the step. Therefore, in order to prepare a uniform final product, crushing is added. For crushing, either wet crushing or dry crushing may be performed. In addition, as the crushing device, known devices for crushing solids such as a ball mill, a vibrating mill, a chopper stirring type crusher, a jet mill, and an atomizer can be used. In the embodiment, solidified components and alumina balls are put into a crushing pod, and crushing is performed by rotating the pod in a wet manner. Here, the rotation time (crushing time) of the pod is adjusted according to the target particle size. After wet crushing, crushed components collected from the pod are dried by spray drying or the like.

Here, the average particle size of the spherical alumina particles in each step refers to a median diameter (D₅₀) measured by a known particle size measurement method such as a laser diffraction scattering method and a dynamic scattering method. Here, the average particle size (D₅₀) of the spherical alumina particles is preferably 30 μm or less, and more preferably 20 μm or less.

As described above, in the spherical alumina particles (that is, high-purity alumina particles) that are produced from the raw material metallic aluminum through the particle formation step, the dissolving step, the drying step, and as necessary, washing, compared to the metallic aluminum in the raw material stage, the total amount of impurities such as elemental uranium and elemental thorium, as well as sodium and iron, is greatly reduced. As will be clearly understood from examples to be described below, the amount of metallic aluminum contained in the spherical particles (components that are not oxidized and converted into alumina) is reduced to 1/10 or less and even to 6/100 or less of the amount contained in the original raw material metallic aluminum. Therefore, it is possible to further reduce the dose of particle rays such as alpha rays and beta rays and electromagnetic waves such as gamma rays emitted from the spherical particles and it is possible to reduce the influence on electronic components and the like.

The spherical aluminum particles produced by oxidation of the metallic aluminum powder are dissolved in a basic solution, and the metallic aluminum remaining in the spherical aluminum particles is converted from a metallic state to aluminum hydroxide, which is a hydroxide. In this case, the amount of impurity components contained in the raw material metallic aluminum is thought to be smaller than the amount that dissolves in the basic solution. Since heavy elements such as U (uranium) and Th (thorium) are not amphoteric elements, they do not easily dissolve in the basic solution but remain as insoluble components. Such ease of dissolving in the basic solution makes it possible to separate elemental uranium, elemental thorium, and other impurity components. Therefore, it is possible to further reduce the amount of impurity components compared to the conventional preparation of oxides for fillers.

In addition, depending on conditions for dissolving in the basic solution, the oxide film formed on the surface of metallic aluminum upon contact with the basic solution is also dissolved, and thus the amount of undissolved metallic aluminum remaining in the high-purity alumina particles can be reduced.

The high-purity alumina particles are characterized by being prepared from alumina particles derived from metallic aluminum. Here, the content of elemental uranium in the alumina particles is 5 ppb or less, and preferably 1 ppb or less, and the content of elemental thorium in the alumina particles is 5 ppb or less, and preferably 1 ppb or less. The amounts of elemental uranium and elemental thorium, which are particularly desired to be reduced, can be significantly reduced.

In addition, the content of sodium in the alumina particles is 10 ppm or less, preferably 5 ppb or less, and more preferably 1 ppb or less, and the content of iron in the alumina particles is 10 ppm or less, preferably 5 ppb or less, and more preferably 1 ppm or less. In this manner, the amount of impurity components other than aluminum is reduced so that very pure high-purity alumina particles can be obtained.

In addition, the content of metallic aluminum in the high-purity alumina particles (alumina particles) is 5 ppm or less, preferably 3 ppb or less, and more preferably 1 ppm or less. That is, the amount of metallic aluminum remaining in the final high-purity alumina particles (spherical alumina particles) is reduced as much as possible. As described above, if metallic aluminum remains in the high-purity alumina particles, the influence of elemental uranium and elemental thorium remaining in the metallic aluminum cannot be eliminated. In addition, since metallic aluminum is a conductor, there is a risk of electrical conductivity when the high-purity alumina particles are used as a filler for electronic materials. Therefore, in order to promote dissolution of metallic aluminum in a basic solution as much as possible, the amount of metallic aluminum remaining in the final high-purity alumina particles (spherical alumina particles) is determined.

In addition, the amount of remaining aluminum particles having a particle size of 20 μm or more derived from the raw material metallic aluminum is 10 particles or less, preferably 5 particles or less, and more preferably 0 particles (not detected) per 50 g of high-purity alumina particles (spherical alumina particles). When metallic aluminum particulates having a size of 20 μm or more remain in the final high-purity alumina particles (spherical alumina particles), the electric insulating properties of the high-purity alumina particles deteriorate. That is, since metallic aluminum is conductive, the insulation performance as a filler is reduced. Accordingly, there is a risk of electrical defects such as short-circuiting occurring at the site where the resin composition containing high-purity alumina particles as a filler is applied. Therefore, the amount of metallic aluminum particulates present in the high-purity alumina particles can be reduced to control the quality of the high-purity alumina particles.

The high-purity alumina particles prepared by the method of producing high-purity alumina particles according to the embodiment described above are mainly used as a filler for electronic materials. The high-purity alumina particles are added to a resin to prepare a resin composition for electronic devices (resin composition containing a filler for electronic materials) (the “resin dispersion step” in the method of producing a resin composition for electronic devices).

Examples of addition target resins include thermoplastic resins such as polyethylene, polypropylene, polyvinyl chloride, polyethylene terephthalate, polystyrene, other olefin resins, polyimide resins, and liquid crystal polymers, and thermosetting resins such as fluorine resins, urea resins, phenol resins, polyphenylene ether, and bismaleimide. In addition, the particles can also be added to elastic resins such as styrene butadiene rubber and isoprene rubber, silicone resins and the like. For example, when resin substrates such as an electronic component package substrate and an interlayer insulation film are produced, epoxy resins are used as the resins.

Examples of epoxy resins used in the resin composition include a bisphenol A type epoxy resin, a bisphenol F type epoxy resin, a biphenyl type epoxy resin, a phenol novolac type epoxy resin, a naphthalene type epoxy resin, and a phenoxy type epoxy resin. The weight of the high-purity alumina particles added to the resin composition is preferably large in consideration of the heat resistance and coefficient of thermal expansion. It is desirable to add 80 mass % or more of the high-purity alumina particles (filler for electronic materials) with respect to a total mass of the resin composition.

In addition, the high-purity alumina particles (filler for electronic materials) according to the embodiment can be prepared as an electronic material slurry in which the filler for electronic materials is dispersed and which contains a liquid dispersion medium substantially free of water. As the dispersion medium, solvents, for example, methyl alcohol, ethyl alcohol, isopropyl alcohol, acetone, methyl ethyl ketone, methyl isobutyl ketone, cyclohexanone, methyl acetate, ethyl acetate, toluene, N-methylpyrrolidone, γ-butyrolactone, propylene glycol monomethyl ether, and propylene glycol monomethyl ether acetate are used. The dispersion mediums may be used alone or a plurality thereof may be used in combination. In addition, it is also possible to use an appropriate dispersing agent.

The characteristic property of the resin composition for electronic devices (resin composition containing a filler for electronic materials) is that, as described for the high-purity alumina particles, it is possible to reduce the dose of particle rays and electromagnetic waves emitted from the spherical particles contained in the resin composition. Therefore, it is possible to reduce the influence of particle rays and electromagnetic waves on electronic components and the like from the processed part of the resin composition. As a result, by reducing external disturbance factors such as noise, problems such as device malfunctions are reduced.

### EXAMPLES

In order to verify the method of producing high-purity alumina particles, Test Examples 1 to 29 were prepared, and the physical properties of the test examples were evaluated. Hereinafter, raw materials used, a production method, and measurement and evaluation methods will be described in that order. For details of prototype examples, refer to Table 1 to Table 6 below.

### [Raw Materials Used]

For the metallic aluminum in Test Examples 1 to 6, a general-purpose aluminum powder having an average particle size of 20 μm was used.

For the metallic aluminum in Test Examples 7 to 22, a high-purity aluminum powder having an average particle size of 20 μm was used.

For the alumina particles in Test Examples 23, 25, and 27, high-purity alumina particles having an average particle size of 0.2 μm were used.

For the alumina particles in Test Examples 24, 26, 28, and 29, high-purity alumina particles having an average particle size of 10 μm were used.

When the basic solution was prepared, the following amine compounds were used.
Ammonia: commercially available from FUJIFILM Wako Pure Chemical Corporation
Dimethylamine: commercially available from FUJIFILM Wako Pure Chemical Corporation
Tetramethylammonium hydroxide (hereinafter referred to as TMAH): commercially available from FUJIFILM Wako Pure Chemical Corporation
Diazabicycloundecene (hereinafter referred to as DBU): commercially available from FUJIFILM Wako Pure Chemical Corporation

### [Confirmation of Solubility of Metallic Aluminum]

### Test Examples 1 to 22

0.2 g of metallic aluminum particles of each test example, 100 g of deionized water, and an aqueous solution of the base species in the tables were mixed and stirred for the time shown for each test example while heating to 40° C. Test Examples 1 to 12 were a 28% ammonia aqueous solution, Test Examples 13 to 20 were a 50% dimethylamine aqueous solution, Test Example 21 was 25% TMAH, and Test Example 22 was a DBU aqueous solution.

### [Verification of Production of High-Purity Alumina Particles]

### Test Examples 23 to 29

In Test Examples 23 to 29, alumina particles were used as starting raw materials. These were a type of a deflagration reaction, and were verifications aimed at removing, from alumina particles prepared by a vaporized metal combustion method (VMC method), metallic aluminum remaining in the particles.

With respect to 100 g of alumina particles of each test example, 100 g of deionized water was used, and an amine compound serving as a base species was added thereto and dissolved. The amount of the base species was set as the amount according to the test example in the table. Then, the solution of each test example was stirred at 25° C. for 5 hours. After stirring, drying was performed at 160° C., and the spherical alumina particles were collected.

### Component Analysis

When the atomic composition contained in the oxide powder was analyzed, an ICP (inductively coupled plasma optical emission spectroscopy) device ICP-MS (for measuring U and Th) and ICP-AES (for measuring alumina and other impurities), which are commercially available from Shimadzu Corporation, were used.

For the measurement, the alumina powder of each test example was completely dissolved in sulfuric acid to prepare a solution, which was supplied to the device.

### Measurement of Amount of Residual Metallic Aluminum

When the amount of residual metallic aluminum was measured, 50 g of an alumina powder (both before immersion in the basic solution and after immersion in the basic solution) sample of each test example was weighed out and put into a 500 mL Erlenmeyer flask. 220 mL of a 2 M sodium hydroxide solution was put into the flask, and the flask was quickly sealed, and then stirred using a magnetic stirrer at 1,000 to 1,200 rpm. Here, the temperature (T1) at the start of stirring was measured.

Stirring was continued in a sealed state for a time considered sufficient for the reaction between metallic aluminum and sodium hydroxide to be completed (about 15 minutes), and the generated hydrogen was collected in the Erlenmeyer flask. After stirring was stopped, a hydrogen detector tube (Kitagawa gas detector tube hydrogen 137U, commercially available from Komyo Rikagaku Kogyo K.K.) was immediately inserted through an airtight stopper. A gas sampler for the detector tube (Kitagawa gas sampler AP-20, commercially available from Komyo Rikagaku Kogyo K.K.) was attached, 50 mL of the gas was sucked from the sealed Erlenmeyer flask, and the hydrogen concentration was measured.

The detector tube and the gas sampler were removed, and the temperature (T3) in the Erlenmeyer flask was measured through the airtight stopper. Then, water was poured into the Erlenmeyer flask, and the volume (V) of the space in the Erlenmeyer flask was measured from the volume of the water.

From the above measured values, the residual metallic aluminum concentration was measured using the following formula, which follows the equation of the state of an ideal gas and Boyle-Charles's law.

(residual metallic aluminum concentration: ppm)=hydrogen concentration (%)×(273(K)+T1(° C.))×(V(mL)+gas suction amount(mL))/{V(mL)×(273(K)+T3(° C.))}×10000×V(mL)/1000×1/{22.4(L)×(273(K)+T1(° C.))/273(K)}×(reaction molar ratio of residual metal material and hydrogen)×atomic weight of unburned metal×1/amount of sample used(g)

Here, (reaction molar ratio of residual metallic aluminum and hydrogen) is a value indicating the number of moles of hydrogen generated per mole of residual metallic aluminum, and is 1.5 in the case of metallic aluminum.

### Measurement of Residual Metallic Aluminum Particles

Together with the residual metallic aluminum concentration, regarding the remaining metallic aluminum in a particle form, the amount of conductive aluminum particles having a size of 20 μm or more was measured. 300 g of an alumina powder (both before immersion in the basic solution and after immersion in the basic solution) sample was weighed out, 0.1 g of sodium hexametaphosphate was added and the mixture was sieved through a 20 μm sieve. Isopropanol was sprayed continuously from above the sieve for about 8 hours to wash the alumina powder, and the sample was then left for 24 hours and dried.

In the dried alumina powder, the number of objects that appeared to be foreign substances was counted by visual observation using an optical microscope, and the objects were separated from the alumina powder. For the separated foreign substances, electrical conductivity was checked using a tungsten needle. The foreign substances that were confirmed to have electrical conductivity were subjected to qualitative analysis using an energy dispersive X-ray analyzing device (SEM-EDX) and confirmed to be aluminum.

### [Results]

The results of Test Examples 1 to 22 are shown in Tables 1 to 4. In each table, from the top, the weight of metallic aluminum (g), the amount of water in the basic solution (g), the base species, the amount of the base (mol %) relative to the amount of metallic aluminum (Al) (mol), the pH, the temperature (° C.), the time (h), the amount of uranium and the amount of thorium in the final state (ppb), the amount of sodium and the amount of iron in the final state (ppm), and the solubility evaluation (A, B, C, and D) are shown.

The solubility evaluation was rated on the following four-grade scale, with A being the best, B being good, C being normal, and D being poor in order.
Evaluation A indicates that all metal particles turned white and were converted into aluminum hydroxide.
Evaluation B indicates that whitening progressed to some extent, but metallic aluminum could be observed with the naked eye.
Evaluation C indicates that the amount of metallic aluminum was larger than that in the above evaluation B.
Evaluation D indicates that conversion into aluminum hydroxide was hardly noticeable.

In Test Examples 23 to 29, a method obtained by adding a step of dissolution in the basic solution to the conventional method of producing alumina powder by the VMC method starting from a metal powder was used. Here, the VMC method was a method of producing true spherical oxide fine particles using a metal powder deflagration phenomenon.

TABLE 1

| | Test | Test | Test | Test | Test | Test |
|---|---|---|---|---|---|---|
| | Example 1 | Example 2 | Example 3 | Example 4 | Example 5 | Example 6 |
| Aluminum | 0.2 | 0.2 | 0.2 | 0.2 | 0.2 | 0.2 |
| (g) | | | | | | |
| Water (g) | 100 | 100 | 100 | 100 | 100 | 100 |
| Base species | 28% | 28% | 28% | 28% | 28% | 28% |
| | ammonia | ammonia | ammonia | ammonia | ammonia | ammonia |
| Amount of | 0.1 | 0.5 | 2 | 0.1 | 0.5 | 2 |
| base | | | | | | |
| (%/relative | | | | | | |
| to powder Al) | | | | | | |
| pH | 9 | 10 | 12 | 9 | 10 | 12 |
| Temperature | 40 | 40 | 40 | 40 | 40 | 40 |
| (° C.) | | | | | | |
| Time (h) | 3 | 3 | 3 | 20 | 20 | 20 |
| Amount of | 400 | 400 | 400 | 400 | 400 | 400 |
| U (ppb) | | | | | | |
| Amount of | 20 | 20 | 20 | 20 | 20 | 20 |
| Th (ppb) | | | | | | |
| Amount of | <1 | <1 | <1 | <1 | <1 | <1 |
| Na (ppm) | | | | | | |
| Amount of | 1000 | 1000 | 1000 | 1000 | 1000 | 1000 |
| Fe (ppm) | | | | | | |
| Solubility | C | C | B | A | A | A |
| evaluation | | | | | | |
| (A to D) | | | | | | |

TABLE 2

| | Test | Test | Test | Test | Test | Test |
|---|---|---|---|---|---|---|
| | Example 7 | Example 8 | Example 9 | Example 10 | Example 11 | Example 12 |
| Aluminum | 0.2 | 0.2 | 0.2 | 0.2 | 0.2 | 0.2 |
| (g) | | | | | | |
| Water (g) | 100 | 100 | 100 | 100 | 100 | 100 |
| Base species | 28% | 28% | 28% | 28% | 28% | 28% |
| | ammonia | ammonia | ammonia | ammonia | ammonia | ammonia |
| Amount of | 0.1 | 0.5 | 2 | 0.1 | 0.5 | 2 |
| base | | | | | | |
| (%/relative | | | | | | |
| to powder Al) | | | | | | |
| pH | 9 | 10 | 12 | 9 | 10 | 12 |
| Temperature | 40 | 40 | 40 | 40 | 40 | 40 |
| (° C.) | | | | | | |
| Time (h) | 3 | 3 | 3 | 20 | 20 | 20 |
| Amount of | <1 | <1 | <1 | <1 | <1 | <1 |
| U (ppb) | | | | | | |
| Amount of | <1 | <1 | <1 | <1 | <1 | <1 |
| Th (ppb) | | | | | | |
| Amount of | <1 | <1 | <1 | <1 | <1 | <1 |
| Na (ppm) | | | | | | |
| Amount of | <1 | <1 | <1 | <1 | <1 | <1 |
| Fe (ppm) | | | | | | |
| Solubility | D | D | C | C | C | B |
| evaluation | | | | | | |
| (A to D) | | | | | | |

TABLE 3

| | Test | Test | Test | Test | Test | Test |
|---|---|---|---|---|---|---|
| | Example 13 | Example 14 | Example 15 | Example 16 | Example 17 | Example 18 |
| Aluminum | 0.2 | 0.2 | 0.2 | 0.2 | 0.2 | 0.2 |
| (g) | | | | | | |
| Water (g) | 100 | 100 | 100 | 100 | 100 | 100 |
| Base species | 50% | 50% | 50% | 50% | 50% | 50% |
| | dimethylamine | dimethylamine | dimethylamine | dimethylamine | dimethylamine | dimethylamine |
| Amount of | 0.42 | 0.21 | 0.04 | 0.42 | 0.21 | 0.04 |
| base | | | | | | |
| (%/relative | | | | | | |
| to powder Al) | | | | | | |
| pH | 10 | 10 | 9 | 10 | 10 | 9 |
| Temperature | 40 | 40 | 40 | 40 | 40 | 40 |
| (° C.) | | | | | | |
| Time (h) | 3 | 3 | 3 | 20 | 20 | 20 |
| Amount of | <1 | <1 | <1 | <1 | <1 | <1 |
| U (ppb) | | | | | | |
| Amount of | <1 | <1 | <1 | <1 | <1 | <1 |
| Th (ppb) | | | | | | |
| Amount of | <1 | <1 | <1 | <1 | <1 | <1 |
| Na (ppm) | | | | | | |
| Amount of | <1 | <1 | <1 | <1 | <1 | <1 |
| Fe (ppm) | | | | | | |
| Solubility | B | C | D | A | A | B |
| evaluation | | | | | | |
| (A to D) | | | | | | |

TABLE 4

| | | | Test | Test |
|---|---|---|---|---|
| | Test Example | Test Example | Example | Example |
| | 19 | 20 | 21 | 22 |
| Aluminum | 0.2 | 0.2 | 0.2 | 0.2 |
| (g) | | | | |
| Water (g) | 100 | 100 | 100 | 100 |
| Base species | 50% | 50% | 25% | DBU |
| | dimethylamine | dimethylamine | TMAH | |
| Amount of | 0.42 | 0.42 | 0.42 | 0.42 |
| base | | | | |
| (%/relative | | | | |
| to powder | | | | |
| Al) | | | | |
| pH | 10 | 10 | 10 | 10 |
| Temperature | 20 | 20 | 20 | 20 |
| (° C.) | | | | |
| Time (h) | 3 | 20 | 3 | 3 |
| Amount of | <1 | <1 | <1 | <1 |
| U (ppb) | | | | |
| Amount of | <1 | <1 | <1 | <1 |
| Th (ppb) | | | | |
| Amount of | <1 | <1 | <1 | <1 |
| Na (ppm) | | | | |
| Amount of | <1 | <1 | <1 | <1 |
| Fe (ppm) | | | | |
| Solubility | D | D | A | A |
| evaluation | | | | |
| (A to D) | | | | |

### [Consideration of Dissolution of Metallic Aluminum Powder]

In Test Examples 1 to 6, the general-purpose metallic aluminum powders were used and generally contained larger amounts of impurities than the high-purity metallic aluminum powders of Test Examples 7 to 22. Since the purity of aluminum was not high, adjusting the pH of the dissolution condition with the basic solution had little effect on the solubility evaluation (refer to Test Examples 4, 5, and 6). On the other hand, the solubility evaluation of the high-purity metallic aluminum powder deteriorated in Test Examples 10, 11, and 12 even under the same conditions. Therefore, it was difficult to apply the conditions for dissolving the general-purpose metallic aluminum powder in the basic solution as the conditions for dissolving the high-purity metallic aluminum powder in the basic solution without change.

Accordingly, as shown in Test Examples 13 to 22, when the type of the amine compound in the basic solution, the amount of the base, the pH, and the dissolution time were selected, good dissolution of the high-purity metallic aluminum powder in the basic solution could be achieved.

The results of Test Examples 23 to 29 are shown in Table 5 and Table 6. In each table, from the top, the weight of alumina powder (g), the amount of water in the basic solution (g), the base species, the amount of the base (mol %) relative to the amount of metallic aluminum (Al) (mol), the pH, the temperature (° C.), the time (h), the amount of metallic aluminum in alumina powder (both before immersion in the basic solution and after immersion in the basic solution) (ppm), the amount of conductive aluminum particles having a size of 20 μm or more (both before immersion in the basic solution and after immersion in the basic solution) (particles/50 g), the amount of uranium and the amount of thorium in the final state (ppb), and the amount of sodium and the amount of iron in the final state (ppm) are shown.

TABLE 5

| | Test | Test | Test | Test |
|---|---|---|---|---|
| | Example | Example | Example | Example |
| | 23 | 24 | 25 | 26 |
| Alumina (g) | 100 | 100 | 100 | 100 |
| Water (g) | 100 | 100 | 100 | 100 |
| Base species | 50% | 50% | 50% | 50% |
| | dimethyl- | dimethyl- | dimethylamine | dimethylamine |
| | amine | amine | | |
| Amount of | 0.42 | 0.42 | 0.21 | 0.21 |
| base | | | | |
| (%/relative to | | | | |
| powder) | | | | |
| pH | 10 | 10 | 10 | 10 |
| Temperature | 25 | 25 | 25 | 25 |
| (° C.) | | | | |
| Time (h) | 5 | 5 | 5 | 5 |
| Amount of | 5 | 105 | 5 | 105 |
| aluminum | | | | |
| before | | | | |
| reduction | | | | |
| (ppm) | | | | |
| Amount of | <1 | <1 | <1 | <1 |
| aluminum after | | | | |
| reduction | | | | |
| (ppm) | | | | |
| Amount of | 20 | 100< | 22 | 100< |
| conductive | | | | |
| aluminum | | | | |
| having size of | | | | |
| 20 μm or more | | | | |
| before | | | | |
| reduction | | | | |
| (particles/50 g) | | | | |
| Amount of | 0 | 0 | 0 | 0 |
| conductive | | | | |
| aluminum | | | | |
| having size of | | | | |
| 20 μm or more | | | | |
| after reduction | | | | |
| (particles/50 g) | | | | |
| Amount of U | <1 | <1 | <1 | <1 |
| (ppb) | | | | |
| Amount of Th | <1 | <1 | <1 | <1 |
| (ppb) | | | | |
| Amount of Na | <1 | <1 | <1 | <1 |
| (ppm) | | | | |
| Amount of Fe | <1 | <1 | <1 | <1 |
| (ppm) | | | | |

TABLE 6

| | Test | | |
|---|---|---|---|
| | Example 27 | Test Example 28 | Test Example 29 |
| Alumina (g) | 100 | 100 | 100 |
| Water (g) | 100 | 100 | 100 |
| Base species | 50% | 25% TMAH | DBU |
| | dimethylamine | | |
| Amount of base | 0.04 | 0.42 | 0.42 |
| (%/relative to | | | |
| powder) | | | |
| pH | 10 | 10 | 10 |
| Temperature | 25 | 25 | 25 |
| (° C.) | | | |
| Time (h) | 5 | 5 | 5 |
| Amount of | 5 | 105 | 105 |
| aluminum | | | |
| before reduction | | | |
| (ppm) | | | |
| Amount of | 5 | <1 | <1 |
| aluminum after | | | |
| reduction (ppm) | | | |
| Amount of | 25 | 100< | 100< |
| conductive | | | |
| aluminum | | | |
| having size of | | | |
| 20 μm or more | | | |
| before reduction | | | |
| (particles/50 g) | | | |
| Amount of | 20 | 0 | 0 |
| conductive | | | |
| aluminum | | | |
| having size of | | | |
| 20 μm or more | | | |
| after reduction | | | |
| (particles/50 g) | | | |
| Amount of U | <1 | <1 | <1 |
| (ppb) | | | |
| Amount of Th | <1 | <1 | <1 |
| (ppb) | | | |
| Amount of Na | <1 | <1 | <1 |
| (ppm) | | | |
| Amount of Fe | <1 | <1 | <1 |
| (ppm) | | | |

### [Consideration of Dissolution of Alumina Powder]

In Test Examples 23 to 29, even though the amount of metallic aluminum and the number of particles were large before immersion in the basic solution, it was confirmed that the amount of metallic aluminum and the number of particles were reduced through immersion in the basic solution regardless of the initial amount. Specifically, it was 1 ppm or less and 0 particles. Therefore, the effectiveness of immersing the alumina particles (powder) in the basic solution became clear retrospectively. Here, in Test Example 27, the amount of the base was thought to be too small.

Based on this series of results, it is possible to reduce the amount of impurity components in the preparation of alumina powder starting from metallic aluminum, and subsequently reduce the amount of poorly soluble metallic aluminum from the alumina powder, and dramatically improve the properties of alumina powder fillers. Therefore, it is expected to contribute to the improvement of the resin composition for electronic devices.

1. High-purity alumina particles comprising alumina particles derived from metallic aluminum,
wherein the content of elemental uranium in the alumina particles is 5 ppb or less,
the content of elemental thorium in the alumina particles is 5 ppb or less,
the content of metallic aluminum in the alumina particles is 5 ppm or less,
the content of sodium in the alumina particles is 10 ppm or less, and
the content of iron in the alumina particles is 10 ppm or less.

2. The high-purity alumina particles according to claim 1,
wherein the amount of remaining aluminum particles having a particle size of 20 μm or more derived from the raw material metallic aluminum is 10 particles or less per 50 g of the alumina particles.

3. A resin composition for electronic devices, comprising the high-purity alumina particles according to claim 1 and a resin composition.

4. A method of producing the high-purity alumina particles according to claim 1, the method comprising:
putting, as a particle formation step, a metallic aluminum powder into a flame, the metallic aluminum powder, and obtaining spherical alumina particles through spheroidization due to surface tension during cooling;
putting, as a dissolving step, the spherical alumina particles into a basic solution to dissolve metallic aluminum remaining in the spherical alumina particles; and
drying, as a drying step, the spherical alumina are particles.

5. The method of producing high-purity alumina particles according to claim 4,
wherein the basic solution is an aqueous amine compound solution.

6. The method of producing high-purity alumina particles according to claim 4,
wherein, in the dissolving step, the spherical alumina particles are dissolved in the basic solution having a pH of 9 or more and a liquid temperature of 20 to 60° C. to dissolve metallic aluminum remaining in the spherical alumina particles.

7. The method of producing high-purity alumina particles according to claim 4,
wherein, in the dissolving step, the spherical alumina particles are sieved.

8. The method of producing high-purity alumina particles according to claim 4, the method further comprising:
washing, as a washing step, the spherical alumina particles before the drying step.

9. A method of producing the resin composition for electronic devices according to claim 3, comprising:
putting, as a particle formation step, a metallic aluminum powder into a flame, vaporizing and oxidizing the metallic aluminum powder, and obtaining spherical alumina particles through spheroidization due to surface tension during cooling;
putting, as a dissolving step, the spherical alumina particles into a basic solution having a pH of 9 or more and a liquid temperature of 20 to 60° C. to dissolve metallic aluminum remaining in the spherical alumina particles;
drying, as a drying step, the spherical alumina particles; and
dispersing, as a resin dispersion step, the spherical alumina particles that have been subjected to the drying step in a resin composition to obtain a resin dispersion.
